(19) United States
(12) Patent Application Publication
(10) Pub. No.: US 2026/0163241 A1
(43) Pub. Date: Jun. 11, 2026

(54) ANTENNA, ANTENNA DEVICE, AND ANTENNA UNIT

(71) Applicant: YOKOWO CO., LTD., Tokyo (JP)

(72) Inventor: Seiya HIROKI, Tomioka-Shi, Gunma (JP)

(73) Assignee: YOKOWO CO., LTD., Tokyo (JP)

(21) Appl. No.: 18/717,924

(22) PCT Filed: Mar. 13, 2024
(86) PCT No.: PCT/JP2024/009671

§ 371 Date: Jun. 7, 2024

(30) Foreign Application Priority Data
Aug. 10, 2023 (JP) 2023-130946

(51) Int. Cl. H01Q 9/38; H01Q 21/06

(52) U.S. Cl. CPC H01Q 9/38; H01Q 21/06

(57) ABSTRACT

An antenna includes a feed portion, a first element connected to the feed portion, the first element rising from a surface of a predetermined member, and a second element connected to the feed portion, the second element extending along a direction in which an angle formed by the second element with the surface is smaller than an angle formed by the first element with the surface.

### TECHNICAL FIELD

The present disclosure relates to an antenna, an antenna device, and an antenna unit.

### BACKGROUND ART

PTL 1 describes a monopole antenna, and PTL 2 describes a dipole antenna.

### CITATION LIST

### Patent Literature

[PTL 1] Japanese Patent Application Publication No. 2014-197821

[PTL 2] Japanese Patent Application Publication No. 2021-121046

### SUMMARY OF INVENTION

### Technical Problem

A monopole antenna and a dipole antenna have different operating principles, and thus these antennas are respectively used according to installation conditions. It has been difficult to meet various installation conditions with only either one of the monopole antenna or the dipole antenna.

The present disclosure is directed to meeting various installation conditions with a single antenna. The present disclosure is directed also to others, which will become apparent from the description of the present Description.

### Solution to Problem

An aspect of the present disclosure is an antenna comprising: a feed portion; a first element connected to the feed portion, the first element rising from a surface of a predetermined member; and a second element connected to the feed portion, the second element extending along a direction in which an angle formed by the second element with the surface is smaller than an angle formed by the first element with the surface.

Another aspect of the present disclosure is an antenna device comprising: a first antenna; and a first coaxial cable connected to the first antenna, the first antenna including a first feed portion, a first element connected to the first feed portion, the first element rising with respect to a surface of a predetermined member, and a second element connected to the first feed portion, the second element extending along a direction in which an angle formed by the second element with the surface is smaller than an angle formed by the first element with the surface.

Still another aspect of the present disclosure is an antenna unit comprising a plurality of antennas, wherein each of the plurality of antennas includes a feed portion, and a first element and a second element, the first element and the second element being configured to be fed at the feed portion, the first element rises with respect to a surface of a predetermined member, the second element extends along a direction in which an angle formed by the second element with the surface is smaller than an angle formed by the first element with the surface, and the plurality of antennas are close to or in contact with each other.

According to aspects described above of the present disclosure, various installation conditions can be met with a single antenna.

### BRIEF DESCRIPTION OF DRAWINGS

FIG. 1 is a perspective view of an antenna device 100 in an embodiment of the present disclosure.

FIG. 2 is an exploded perspective view of an antenna device 100 in an embodiment of the present disclosure.

FIG. 3A is a side view illustrating how coaxial cables are connected to a first antenna 10 and a second antenna 20, respectively, when viewed from a +X direction.

FIG. 3B is a side view illustrating how a first antenna 10 is connected to a coaxial cable, when viewed from a +Y direction.

FIG. 4A is an explanatory diagram illustrating a model of a first antenna 10 arranged in free space.

FIG. 4B is an explanatory diagram illustrating a model of a first antenna 10 arranged close to an external member (or internal member) 70.

FIG. 5 is a diagram illustrating the frequency characteristics of VSWR of a first antenna 10 and a second antenna 20 arranged in free space.

FIG. 6 is a diagram illustrating the frequency characteristics of VSWR of a first antenna 10 and a second antenna 20 arranged close to an external member (or internal member) 70.

FIG. 7A is a perspective view of an antenna device 100A of a first modification example.

FIG. 7B is a perspective view illustrating how coaxial cables are connected to a first antenna 10A and a second antenna 20A, respectively.

FIG. 8A is a perspective view of an antenna device 100B of a second modification example.

FIG. 8B is a perspective view illustrating how coaxial cables are connected to a first antenna 10B, a second antenna 20B, a third antenna 110B, and a fourth antenna 120B, respectively.

FIG. 9A is an explanatory diagram illustrating a model of a first antenna unit 91 in an embodiment of the present disclosure arranged in free space.

FIG. 9B is an explanatory diagram illustrating a model of a first antenna unit 91 in an embodiment of the present disclosure arranged close to an external member (or internal member) 70.

FIG. 10A is an explanatory diagram illustrating a model of a second antenna unit 92 in an embodiment of the present disclosure arranged in free space.

FIG. 10B is an explanatory diagram illustrating a model of a second antenna unit 92 of an embodiment of the present disclosure arranged close to an external member (or internal member) 70.

FIG. 11A is an explanatory diagram illustrating a model of an antenna unit 90 of a comparative example arranged in free space.

FIG. 11B is an explanatory diagram illustrating a model of an antenna unit 90 of a comparative example arranged close to an external member (or an internal member) 70.

FIG. 12 is a diagram illustrating frequency characteristics of isolation among a first antenna unit 91, a second antenna unit 92, and an antenna unit 90 arranged in free space.

FIG. 13 is a diagram illustrating frequency characteristics of isolation among a first antenna unit 91, a second antenna unit 92, and an antenna unit 90 arranged close to an external member (or internal member) 70.

FIG. 14 is a perspective view illustrating how a first coaxial cable 81 is connected to a second element 13 and how a second coaxial cable 82 is connected to a fourth element 23.

FIG. 15A is a perspective view illustrating a state in the middle of assembling a holder 30, and a first element 12 and a third element 22.

FIG. 15B is a perspective view illustrating a state in which the assembly of a holder 30, and a first element 12 and a third element 22 is completed.

FIG. 16A is a perspective view illustrating a state in the middle of assembling the holder 30, and the second element 13 and the fourth element 23.

FIG. 16B is a perspective view illustrating a state in which the assembly of a holder 30, and a second element 13 and a fourth element 23 is completed.

FIG. 17 is a perspective view illustrating a state in which the assembly of a base portion 2 and a holder 30 is completed.

### DESCRIPTION OF EMBODIMENTS

At least the following matters will become apparent from the description of the present Description and the accompanying drawings.

With reference to the drawings, preferred embodiments of the present disclosure will be described below. The same or equivalent components, members, and the like illustrated in the drawings are denoted by the same reference numerals, and redundant description thereof is omitted as appropriate.

### Embodiments

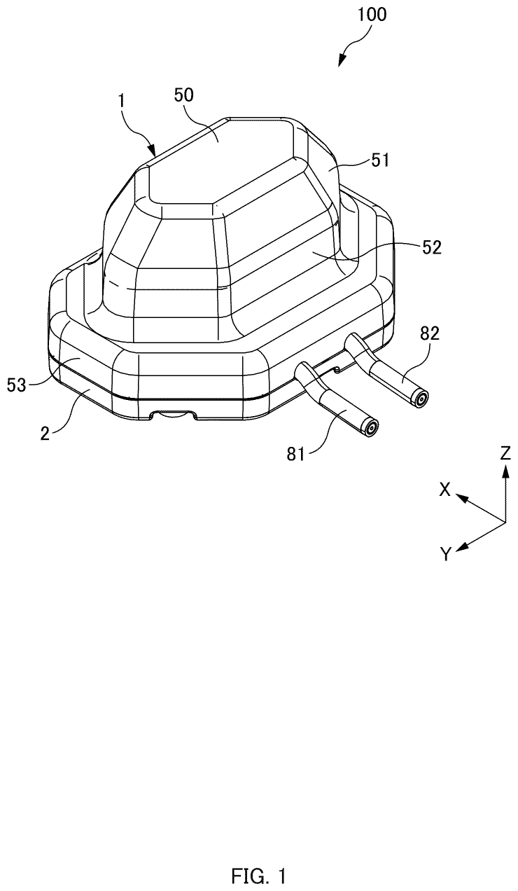

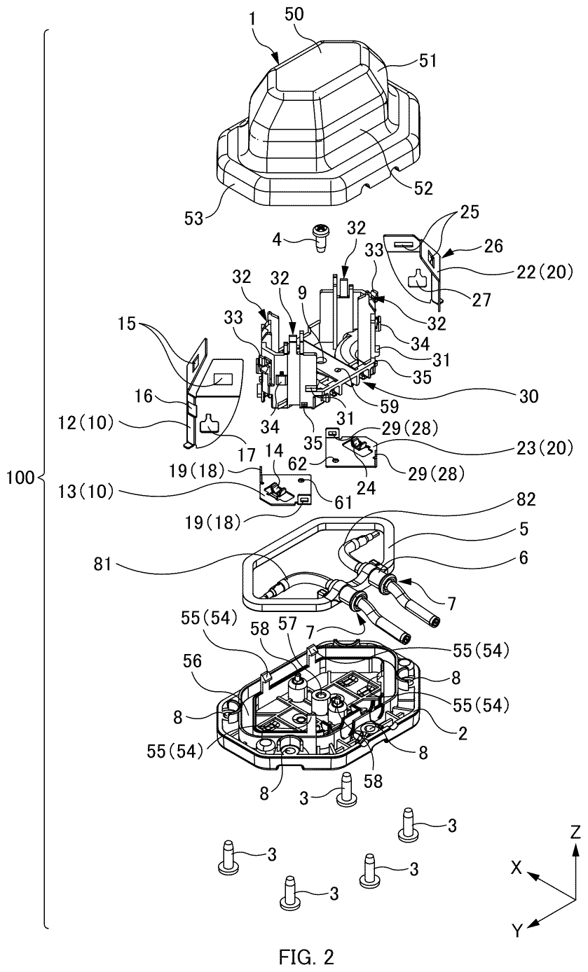

FIG. 1 is a perspective view of an antenna device 100 in an embodiment of the present disclosure. FIG. 2 is an exploded perspective view of the antenna device 100 in an embodiment of the present disclosure.

### <<Definition of Directions and the Like>>

First, directions and the like in the antenna device 100 of an embodiment of the present disclosure will be defined with reference to FIGS. 1 and 2.

A “+X direction” is defined as a direction in which coaxial cables (specifically, a first coaxial cable 81 and a second coaxial cable 82 which will be described later) are inserted into the antenna device 100, and a “−X direction” is defined as a direction opposite thereto (that is, the direction in which the coaxial cables extend from the inside of the antenna device 100). In addition, a “+Y direction” is defined as a direction perpendicular to the +X direction and the direction from the second coaxial cable 82 to the first coaxial cable 81, and a “−Y direction” is a direction opposite thereto (that is, the direction from the first coaxial cable 81 toward the second coaxial cable 82). Further, a “+Z direction” is defined as a direction perpendicular to the +X direction and +Y direction and the direction from a base portion 2 (described later) to a case portion 1 (described later), and a “−Z direction” is a direction opposite thereto (that is, the direction from the case portion 1 to the base portion 2).

The +X direction, the −X direction, the +Y direction, the −Y direction, the +Z direction, and the −Z direction are directions with fixed orientations. Instead of the directions with fixed orientations as described above, both the +X direction and the −X direction may be simply referred to as “X direction”. Similarly, both the +Y direction and the −Y direction may be simply referred to as “Y direction”. Further, both the +Z direction and the −Z direction may be simply referred to as “Z direction”.

In FIGS. 1 and 2, each direction of the +X, +Y, and +Z directions is indicated by a line with an arrow for easy understanding of the directions and the like in the antenna device 100. The point of intersection among these lines with arrows does not mean the coordinate origin.

The antenna device 100 of an embodiment of the present disclosure is arranged such that the +Z direction will be a zenith direction. Accordingly, in the following description, the +Z direction may be referred to as “upward direction”, and the −Z direction may be referred to as “downward direction”. Further, the Z direction may also be referred to as “up-down direction” or “height direction”. Furthermore, the surface of each component of the antenna device 100 on the +Z direction side may be referred to as “top surface”, and the surface of each component of the antenna device 100 on the −Z direction side may be referred to as “bottom surface”.

The definitions of directions and the like described above are common in other embodiments of the present Description as well, unless otherwise specified.

### <<Overview of Antenna Device 100>>

Next, referring again to FIGS. 1 and 2 described above, an overview of the antenna device 100 of an embodiment of the present disclosure will be described.

As illustrated in FIG. 1, the antenna device 100 in an embodiment of the present disclosure includes the case portion 1 and the base portion 2, and houses multiple antennas, which will be described later, within a housing space of the case portion 1. The case portion 1 has an upper surface portion 50, an inclined surface portion 51, a first outer circumferential surface portion 52, and a second outer circumferential surface portion 53, from the +Z direction side to the −Z direction side. The antenna device 100 may be defined as the antenna device 100 including coaxial cables 81 and 82, or the antenna device 100 excluding the coaxial cables 81 and 82.

The antenna device 100 is an antenna device to be disposed to an outdoor equipment such as a vending machine, a ticket vending machine, or the like, for example. However, the antenna device 100 may be an antenna device disposed at a structure such as a building, a utility pole, or the like, for example.

Further, the location at which the antenna device 100 is disposed is not limited to outdoor equipment and structures, but can be changed as appropriate, depending on the desired directivity and the like, such as inside a building, on a mountain, on the sea, and the like, for example. Furthermore, the antenna device 100 may be an antenna device to be used for a mobile object such as a vehicle and the like, for example. In this case, the antenna device 100 is arranged at a predetermined location of the vehicle. The antenna device 100 is arranged at various locations of a vehicle such as a front windshield, a rear windshield, a roof, inside an instrument panel, an upper part of a dashboard, an overhead console, a bumper, a mounting part of a license plate, pillar part, a spoiler part, and the like.

The antenna device 100 is not limited to an aspect of being arranged at a vehicle, but may also be brought into a vehicle and used inside the vehicle. Further, although it is assumed that the antenna device 100 is used for a “vehicle” that is a wheeled vehicle, it is not limited thereto. It may be used for a mobile object other than a vehicle, for example, a flight vehicle, such as a drone and the like, a probe vehicle, a construction machinery, an agricultural machinery, a vessel, and the like, without wheels.

The antenna device 100 is connected to a device such as a controller and/or the like through the coaxial cables (the first coaxial cable 81 and the second coaxial cable 82). The term “connect” includes not only a physical connection, but also an electrical connection without a physical connection. This definition f the term “connect” is common in other embodiments of the present Description, unless otherwise specified.

In the following description, a member at which the antenna device 100 is arranged may be referred to as “external member”. For example, when the antenna device 100 is arranged at the top panel of a vending machine, the external member is the top panel of the vending machine, and when the antenna device 100 is arranged at a side panel of a vending machine, the external member is the side panel of the vending machine. Further, for example, when the antenna device 100 is arranged at a vehicle, the external member is a predetermined position of the vehicle at which the antenna device 100 is arranged, such as the roof of the vehicle or the like.

Further, a member at which an antenna 10 and an antenna 20 described later are to be arranged may be referred to as “internal member”. For example, when the antenna 10 and the antenna 20 described later are arranged at the base portion 2 (see FIG. 2) of the antenna device 100, the internal member is the base portion 2 or a part of the housing of the antenna device 100 where the base portion 2 is arranged.

The surface of the external member at which the antenna device 100 is to be arranged, and the surface of the internal member at which the antennas 10 and the antenna 20 (described later) are to be arranged may be referred to as “placement surface” or simply referred as “surface”. For example, when the antenna device 100 is arranged at the top plate of a vending machine, the placement surface is the front surface or the back surface of the top plate of the vending machine that faces the base portion 2 of the antenna device 100 (see FIG. 2). Further, for example, when the antenna device 100 is arranged at a side panel of a vending machine, the placement surface is the front surface or the back surface of the side panel of the vending machine that faces the base portion 2 of the antenna device 100.

Further, for example, when the antenna 10 and the antenna 20 described later are arranged at the base portion 2 (see FIG. 2), the placement surface is a surface, on the side on which the antenna 10 and the antenna 20 described later are arranged, of the base portion 2 or a part of the housing of the antenna device 100 where the base portion 2 is arranged. In an embodiment of the present disclosure, the “front surface” is a surface on the +Z direction side, and the “back surface” is the surface on the −Z direction side.

The antenna device 100 of an embodiment of the present disclosure is an antenna device including multiple antennas. Specifically, the antenna device 100 has two antennas, the first antenna 10 and the second antenna 20, described later. However, the antenna device 100 may have only one antenna, or may have three or more antennas.

The antenna 100 of an embodiment of the present disclosure is used for multiple-input multiple-output (MIMO) communication, for example. In MIMO communication, multiple antennas individually transmit data and receive data simultaneously. In the antenna device 100, data is respectively transmitted from the two antennas, the first antenna 10 and the second antenna 20, and data is respectively received by the two antennas, the first antenna 10 and the second antenna 20, simultaneously.

That is, the antenna device 100 of an embodiment of the present disclosure is used in “2×2 MIMO” communications using two antennas for each of transmission and reception. However, the antenna device 100 may also be used in “4×4 MIMO” communications using four antennas for each of transmission and reception. The antenna device 100 may be used in other than MIMO communications.

The antenna device 100 of an embodiment of the present disclosure supports radio waves in a wide frequency band, such as 2 GHz to 6 GHz for 4G, 5G, and LTE, for example. However, the antenna 100 is not limited thereto, and may support radio waves in a frequency band for part (for example, only 5G) of 4G, 5G, and LTE. Further, the antenna device 100 may support radio waves in a frequency band for telematics, or may support radio waves in a frequency band used for Vehicle to Everything (V2X: vehicle-to-vehicle communication, road-to-vehicle communication).

Furthermore, the antenna device 100 may support radio waves in frequency bands for Global Navigation Satellite System (GNSS), Sirius XM (SXM), and/or Electronic Toll Collection system (ETC). The communication standard and frequency band supported by the antenna device 100 are not limited to those described above, and other communication standards and frequency bands may be used. That is, the antenna device 100 can support radio waves in a desired frequency band.

As illustrated in FIG. 2, the antenna device 100 has the case portion 1, the base portion 2, the first antenna 10, the second antenna 20, the holder 30, the first coaxial cable 81, the second coaxial cable 82, a pad 5, and a grommet 6. As described above, the antenna device 100 may be defined as not including the first coaxial cable 81 or the second coaxial cable 82. In that case, the grommet 6 is not included in the antenna device 100, either.

### <Case Portion 1>

The case portion 1 is a member that forms the exterior of the antenna device 100 together with the base portion 2. The case portion 1 is made of insulating resin such as PC resin, ASA resin, PC/ASA resin composition, ABS resin and/or the like. However, the case portion 1 may be made of a material that is other than insulating resin and that allows radio waves to pass therethrough. Further, the case portion 1 may include a part made of insulating resin and a part that is made of a material other than insulating resin and that allows radio waves to pass therethrough. That is, the case portion 1 may be formed by combining desired materials freely.

In the antenna device 100 of an embodiment of the present disclosure, the case portion 1 is formed such that the size thereof in the X direction and the Y direction gradually increases from the +Z direction side to the −Z direction side. The case portion 1 has the upper surface portion 50, the inclined surface portion 51, the first outer circumferential surface portion 52, and the second outer circumferential surface portion 53, from the +Z direction side to the −Z direction side.

The upper surface portion 50 is a part of the case portion 1 that includes a surface (that is, the upper surface) located at the end part on the +Z direction side. The inclined surface portion 51 is a part including the outer circumferential surface located on the −Z direction side with respect to the upper surface portion 50. The inclined surface portion 51 has a shape that surrounds the outer periphery of the upper surface portion 50 when viewed in the −Z direction. Furthermore, the inclined surface portion 51 is formed such that the outer surface is inclined toward the center of the upper surface portion 50 in the up-down direction. Here, the “center” refers to the central point in the shape formed by the outer edge of the top surface portion 50 when viewed in the −Z direction, that is, the geometric center.

The first outer circumferential surface portion 52 is a part including an outer circumferential surface located on the −Z direction side with respect to the inclined surface portion 51. The first outer circumferential surface portion 52 has a shape that surrounds the outer periphery of the inclined surface portion 51 when viewed in the −Z direction. The second outer circumferential surface portion 53 is a part that includes an outer circumferential surface that is located on the −Z direction side with respect to the first outer circumferential surface portion 52. The second outer circumferential surface portion 53 has a shape that surrounds the outer periphery of the first outer circumferential surface portion 52 when viewed in the −Z direction. When viewed in the −Z direction, the outer periphery of each of the upper surface portion 50, the inclined surface portion 51, the first outer circumferential portion 52 and the second outer circumferential portion 53 has a shape obtained by obliquely cutting off each vertex portion from a rectangular shape.

The case portion 1 on its bottom side forms an opening. The case portion 1 is formed of a closed surface portion including the upper surface portion 50, the inclined surface portion 51, the first outer circumferential surface portion 52, and the second outer circumferential surface portion 53, and an opening on its bottom side, thereby forming a housing space capable of housing the first antenna 10, the second antenna 20, and the like therein, described later. Furthermore, the case portion 1 is formed including the above-described upper surface portion 50, inclined surface portion 51, first outer peripheral surface portion 52 and second outer peripheral surface portion 53, such that the size thereof in the X direction and Y direction gradually increases from the +Z direction side to the −Z direction side.

This allows the case portion 1 forming the exterior of the antenna device 100 to have a shape formed along the outlines of the first antenna 10, second antenna 20, and the like that are housed therein. With the case portion 1 being formed into a shape along the outlines of the first antenna 10, the second antenna 20, and the like housed therein, the entire antenna device 100 can be made more compact. The shape of the case portion 1 is not limited to the shape illustrated in FIGS. 1 and 2, and the case portion 1 can be formed in any desired shape, such as a rectangular parallelepiped shape, a cubic shape, a hemispherical shape, a semi-elliptical spherical shape, or the like, and does not have to be a shape formed along the outlines of the first antenna 10, second antenna 20, and the like housed therein.

The case portion 1 has a screw hole (not illustrated) formed in the second outer circumferential surface portion 53 on its bottom side. The case portion 1 and the base portion 2 can be fixed by inserting the screw 3 illustrated in FIG. 2 into the hole 8 in the base portion 2 and tightening it in a screw hole (not illustrated) formed in the second outer peripheral portion 53 on the bottom side of the case portion 1.

### <Base Portion 2>

The base portion 2 is a member forming the exterior of the antenna device 100 together with the above-described case portion 1. The base portion 2 is made of insulating resin such as PC resin, ASA resin, a PC/ASA resin composition, ABS resin, and/or the like, for example. However, the base portion 2 may be made of a material that is other than insulating resin and that allows radio waves to pass therethrough. Further, the base portion 2 may include a part made of insulating resin and a part that is made of a material other than insulating resin and that allows radio waves to pass therethrough. That is, the base portion 2 may be formed by combining desired materials freely.

In the antenna device 100 of an embodiment of the present disclosure, the base portion 2 is formed in a plate shape parallel to the X direction and the Y direction, and when viewed in the −Z direction, the outer periphery of the base portion 2 has substantially the same size and shape as the outer periphery of the second outer circumferential surface portion 53 of the case portion 1. However, the shape of the base portion 2 is not limited to the shape illustrated in FIGS. 1 and 2, and the base portion 2 can be formed into any desired shape, such as a rectangular parallelepiped shape, a cubic shape, a hemispherical shape, a semi-elliptical parallelepiped shape, or the like.

As illustrated in FIG. 2, the base portion 2 has arm portions 54 that are arranged substantially close to the periphery of the base portion 2 and are arranged along the periphery thereof. The arm portions 54 are formed to extend in the +Z direction from the front surface side of the base portion 2. The base portion 2 has four arm portions 54 having engagement claws 55 formed at the end parts thereof, respectively. The holder 30 can be assembled to the base portion 2 by engaging the engagement claws 55 with the engagement claws 31 (described later) of the holder 30. However, in the antenna device 100, the holder 30 may be assembled to the base portion 2, in an aspect, for example, by screwing, welding, adhesive, and/or the like, other than by engaging the engagement claws 55 of the base portion 2 with the engagement claws 31 of the holder 30.

A pad fitting portion 56 for fitting the pad 5 (described later) therein is formed at the surface of the base portion 2 on the +Z direction side. The pad fitting portion 56 is formed as a recessed portion in the front surface of the base portion 2. The pad 5 is fitted in the pad fitting portion 56 and is fixed by being sandwiched between the case portion 1 and the base portion 2.

The base portion 2 has a screw hole 57 into which a screw 4 is screwed through a hole 9 of the holder 30 described later. Further, the base portion 2 has positioning protrusions 58 that are located on both sides of the screw hole 57 in the X direction, and that protrude in the +Z direction from the front surface side of the base portion 2. The two positioning protrusions 58 and the screw holes 57 are aligned in a direction parallel to the X direction.

### <First Antenna 10 and Second Antenna 20>

Each of the first antenna 10 and the second antenna 20 is an antenna for linearly polarized waves. The linearly polarized waves may be referred to as, for example, vertically polarized waves when the polarization plane is vertical to the ground, and as horizontally polarized waves when the polarization plane is horizontal to the ground. Specifically, the first antenna 10 and the second antenna 20 are wideband antennas based on the shape of a bowtie antenna or a dipole antenna.

In the antenna device 100 of an embodiment of the present disclosure, the first antenna 10 and the second antenna 20 have the same shape and configuration. Here, the phrase “the same shape and configuration” does not necessarily mean that the shape and configuration of the first antenna 10 and the shape and configuration of the second antenna 20 are exactly the same. For example, the shape of the first antenna 10 may be partially different from the shape of the second antenna 20, or may be entirely different. Further, the first antenna 10 may have a configuration different from that of the second antenna 20, and conversely, the second antenna 20 may have a configuration different from that of the first antenna 10.

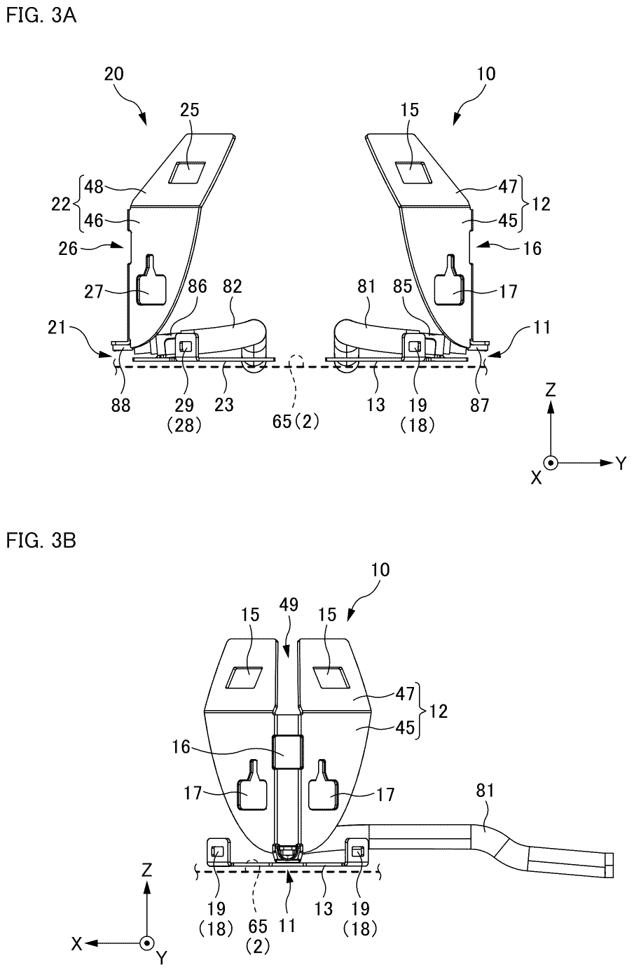

Specifically, the first antenna 10 has a first feed portion 11 (not illustrated in FIG. 2, see FIG. 3A described later), a first element 12 and a second element 13. The second antenna 20 has a second feed portion 21 (not illustrated in FIG. 2, see FIG. 3A described later), a third element 22, and a fourth element 23, which are the same components included in the first antenna 10. The details of the first antenna 10 and the second antenna 20 will be described later.

### <Holder 30>

The holder 30 is a member to support the first antenna 10 and the second antenna 20 such that they face each other. The holder 30 that supports the first antenna 10 and the second antenna 20 is assembled to the base portion 2. The holder 30 is made of insulating resin such as PC resin, ASA resin, a PC/ASA resin composition, ABS resin, and/or the like, for example.

The holder 30 has the engagement claws 31, engagement claws 32, engagement claws 33, engagement claws 34, and engagement claws 35.

The engagement claws 31 are used to assemble the base portion 2 to the holder 30. The base portion 2 can be assembled to the holder 30 by respectively engaging the engagement claws 31 with the engagement claws 55 formed at the end parts of the arm portions 54 of the base portion 2. The holder 30 has four engagement claws 31 having a protruding shape so as to correspond to the four engagement claws 55 of the base portion 2, respectively. However, in FIG. 2, two of the four engagement claws 31 are illustrated, and the remaining two engagement claws 31 are hidden by other parts of the holder 30 and thus not illustrated.

The engagement claws 32, 33 and 34 are parts to support the first element 12 (described later) of the first antenna 10 and the third element 22 (described later) of the second antenna 20.

The holder 30 has two engagement claws 32 aligned in the X direction on the +Y direction side, and two engagement claws 32 aligned in the X direction on the −Y direction side. With the engagement claws 32 on the +Y direction side being engaged with the edges of the engagement holes 15 formed in the first element 12, the holder 30 can support the first element 12. With the engagement claws 32 on the −Y direction side being engaged with the edges of the engagement holes 25 formed in the third element 22, the holder 30 can support the third element 22.

Further, the holder 30 has the engagement claws 33 on the +Y direction side and the −Y direction side, respectively. With the engagement claw 33 on the +Y direction side being engaged with the edge of the engagement hole 16 formed in the first element 12, the holder 30 can support the first element 12. With the engagement claw 33 on the −Y direction side being engaged with the edge of the engagement hole 26 formed in the third element 22, the holder 30 can support the third element 22.

Further, the holder 30 has two engagement claws 34 aligned in the X direction on the +Y direction side, and two engagement claws 34 aligned in the X direction on the −Y direction side. However, in FIG. 2, one engagement claw 34 on the +Y direction side and one engagement claw 34 on the −Y direction side are illustrated, and the remaining two engagement claws 34 are hidden by other parts of the holder 30 and thus not illustrated.

With the engagement claws 34 on the +Y direction side being engaged with the edges of the engagement holes 17 formed in the first element 12, the holder 30 can support the first element 12. With the engagement claws 34 on the −Y direction side being engaged with the edges of the engagement holes 27 formed in the third element 22, the holder 30 can support the third element 22.

The engagement claws 35 are parts to support the second element 13 (described later) of the first antenna 10 and the fourth element 23 (described later) of the second antenna 20. The holder 30 has two engagement claws 35 aligned in the X direction on the +Y direction side, and two engagement claws 35 aligned in the X direction on the −Y direction side. However, in FIG. 2, one engagement claw 35 on the +Y direction side and one engagement claw 35 on the −Y direction side are illustrated, and the remaining two engagement claws 35 are hidden by other parts of the holder 30 and thus not illustrated.

With the engagement claws 35 on the +Y direction side being engaged with the edges of the engagement holes 19 formed in the protruding portions 18 of the second element 13, the holder 30 can support the second element 13. With the engagement claws 35 on the −Y direction side being engaged with the edges of the engagement holes 29 formed in the protruding portions 28 of the fourth element 23, the holder 30 can support the fourth element 23.

The hole 9 is formed at the center of the holder 30 when viewed in the −Z direction. The holder 30 and the base portion 2 can be fixed together by inserting the screw 4 illustrated in FIG. 2 into the hole 9 and tightening it in the screw hole 57 formed at the center of the base portion 2. Further, the holder 30 has positioning holes 59 formed on both sides of the hole 9 in the X direction. The two positioning holes 59 (however, the positioning hole 59 on the +X direction side is not illustrated) and the hole 9 are aligned in a direction parallel to the X direction. Two positioning protrusions 58 protruding in the +Z direction that are formed at the base portion 2 are fitted into these two positioning holes 59, thereby positioning the holder 30 with respect to the base portion 2. When viewed in the Z direction, the position of the hole 9 and the position of the screw hole 57 are aligned with each other. Furthermore, the engagement claws 55 of the four arms 54 of the base portion 2 are engaged with the four engagement claws 31 of the holder 30, respectively. In such a state, the screw 4 is inserted into the hole 9.

### <First Coaxial Cable 81 and Second Coaxial Cable 82>

The first coaxial cable 81 is a feeder connected to the first antenna 10. The second coaxial cable 82 is a feeder connected to the second antenna 20. With each of the first antenna 10 and the second antenna 20 being fed, the first antenna 10 and the second antenna 20 have feed portions (the first feed portion 11 and the second feed portion 21 described later), respectively.

Each of the first coaxial cable 81 and the second coaxial cable 82 may be attached with a magnetic core (for example, a ferrite core) (not illustrated). With a magnetic core being attached to each of the first coaxial cable 81 and the second coaxial cable 82, leakage current can be reduced. However, at least one of the first coaxial cable 81 or the second coaxial cable 82 does not necessarily have to be attached with the magnetic core. For example, the magnetic core may be attached depending on the frequencies supported by the first antenna 10, the second antenna 20.

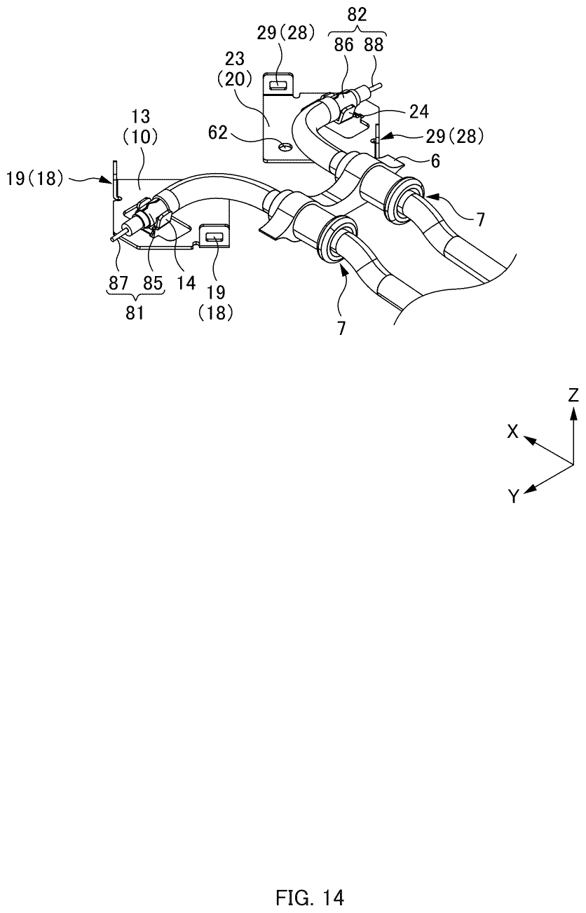

The first coaxial cable 81 has an outer conductor 85 and an inner conductor 87 (not illustrated in FIG. 1 or 2, see FIG. 14 described below). The second coaxial cable 82 also has an outer conductor 86 and an inner conductor 88 (not illustrated in FIG. 1 or 2, see FIG. 14 described below). The outer conductors 85 and 86 are ground lines, and the inner conductors 87 and 88 are signal lines.

### <Pad 5>

The pad 5 is a member to ensure the waterproofness of the housing space for the antenna device 100. The pad 5 is arranged between the case portion 1 and the base portion 2, and further is sandwiched between the case portion 1 and the base portion 2, thereby being able to improve the waterproofness of the housing space for the antenna device 100.

### <Grommet 6>

The grommet 6 is a member to improve the waterproofness around each of the first coaxial cable 81 and the second coaxial cable 82. In the grommet 6, a hole 7 through which the first coaxial cable 81 is inserted is formed the +Y direction side, and another hole 7 through which the second coaxial cable 82 is inserted is formed on the −Y direction side. The first coaxial cable 81 is inserted into the hole 7 on the +Y direction side, and the second coaxial cable 82 is inserted into the hole 7 on the −Y direction side, and further is sandwiched between the case portion 1 and the base portion 2, thereby improving the waterproofness around each of the first coaxial cable 81 and the second coaxial cable 82.

### <<Details of First Antenna 10 and Second Antenna 20>>

Next, details of the first antenna 10 and the second antenna 20 will be described with reference again to the above-described FIGS. 1 and 2 and with reference newly to FIGS. 3A and 3B.

FIG. 3A is a side view illustrating how the coaxial cables are connected to the first antenna 10 and the second antenna 20, respectively, when viewed from the +X direction. FIG. 3B is a side view illustrating how the coaxial cable is connected to the first antenna 10, when viewed from the +Y direction.

### <First Antenna 10>

As described above, the first antenna 10 has the first feed portion 11, the first element 12, and the second element 13.

The first feed portion 11 is a region including a feeding point. Here, the feeding point is a part where the first coaxial cable 81 feeds power to the first element 12 and the second element 13. The feeding point for the first element 12 and the second element 13 is located, for example, between the first element 12 and the second element 13. Specifically, the first feed portion 11 is located at the center of the line segment connecting the end part of the first element 12 closest to the second element 13 (herein, the −Z direction side) and the end part of the second element 13 closest to the first element 12 (herein, the +Y direction side). In the following description, the “center” is not limited to the exact center, but includes a position deviating from the center by a predetermined distance as well.

The first element 12 and the second element 13 are connected to the first feed portion 11 that includes the above-described feeding point.

As illustrated in FIG. 3A, the first element 12 is an element to which the inner conductor 87 of the first coaxial cable 81 is connected. The first element 12 is arranged so as to rise with respect to a placement surface 65 of the base portion 2, for example. In FIGS. 3A and 3B, a part of the placement surface 65 is given by a dashed line.

As illustrated in FIG. 3A, the first element 12 has a rising portion 45 and an inclined portion 47. The rising portion 45 is a part of the first element 12 that is formed so as to rise in the +Z direction from the first feed portion 11, with respect to the placement surface 65 of the base portion 2, for example. The inclined portion 47 is a part that is inclined with respect to the rising portion 45 (specifically, inclined to the −Y direction side with respect to the +Z direction).

As illustrated in FIG. 3B, the first element 12 has a cut portion 49 formed therein. With this cut portion 49 being formed, the two inclined portions 47 branches so as to be arranged side by side in the X direction. In other words, the cut portion 49 is formed between the two inclined portions 47. With the cutout portion 49 being formed between the two inclined portions 47, the bending process of the first element 12 is facilitated when the inclined portions 47 are formed by bending the first element 12 during manufacturing thereof, thereby being able to manufacture the first element 12 easily. However, the first element 12 does not necessarily have to have the cut portion 49 formed therein. Forming the inclined portions 47 of the first element 12 has effect of reducing the height and size of the antenna device 100.

As illustrated in FIG. 3B, in the first element 12, the engagement holes 15, the engagement hole 16, and the engagement holes 17 are formed. The engagement holes 15 are parts with which the engagement claws 32 of the holder 30 are to engage, the engagement hole 16 is a part with which the engagement claw 33 of the holder 30 is to engage, and the engagement holes 17 are parts with which the engagement claws 34 of the holder 30 are to engage.

As illustrated in FIG. 3A, the second element 13 is an element to which the outer conductor 85 of the first coaxial cable 81 is connected. The second element 13 has a second planar portion. In an embodiment of the present disclosure, the second element 13 is arranged to extend along a direction substantially parallel to the placement surface 65 of the base portion 2. However, the direction in which the second element 13 is arranged does not have to be substantially parallel to the placement surface 65 of the base portion 2. The angle of the second element 13 with respect to the placement surface 65 of the base portion 2 may be any angle as long as it is smaller than the angle of the first element 12 with respect to the placement surface of the base portion 2.

As illustrated in FIG. 2, the second element 13 also has a first outer conductor connection portion 14. The first outer conductor connection portion 14 is a part where the outer conductor 85 of the first coaxial cable 81 is connected. The first outer conductor connection portion 14 is located on the +Y direction side in the second element 13. This allows the first coaxial cable 81 connected at the first outer conductor connection portion 14 to be arranged so as to extend, in the −Y direction, beyond the first outer conductor connection portion 14.

The second element 13 includes the protruding portions 18. The protruding portions 18 each have an engagement hole 19 formed therein. The engagement hole 19 is a part with which the engagement claw 35 of the holder 30 is to engage.

### <Second Antenna 20>

As described above, the second antenna 20 has the second feed portion 21, the third element 22 and the fourth element 23.

The second feed portion 21 is a region including a feeding point. Here, the feeding point is a part where the second coaxial cable 82 feeds power to the third element 22 and the fourth element 23. The feeding point for the third element 22 and the fourth element 23 is located between the third element 22 and the fourth element 23, for example. Specifically, the second feed portion 21 is located at the center of the line segment connecting the end part of the third element 22 closest to the fourth element 23 (herein, the −Z direction side) and the end part of the fourth element 23 closest to the third element 22 (herein, the −Y direction side).

The third element 22 is an element to which the inner conductor 88 of the second coaxial cable 82 is connected, as illustrated in FIG. 3A. The third element 22 is arranged so as to rise with respect to the placement surface 65 of the base portion 2, for example.

As illustrated in FIG. 3A, the third element 22 has a rising portion 46 and an inclined portion 48. The rising portion 46 is a part of the third element 22 that is arranged so as to rise in the +Z direction from the second feed portion 21 with respect to the placement surface 65 of the base portion 2, for example. The inclined portion 48 is a part that is inclined with respect to the rising portion 46 (specifically, inclined to the +Y direction side with respect to the +Z direction).

As in the first element 12, the third element 22 also has a cut portion 49 (not illustrated in FIG. 3A). With this cut portion 49 being formed, the two inclined portions 48 branches so as to be arranged side by side in the X direction. In other words, the cut portion 49 is formed between the two inclined portions 48. With the cut portion 49 being formed between the two inclined portions 48, the bending process of the third element 22 is facilitated when the inclined portions 48 are formed by bending the third element 22 during the manufacturing thereof, thereby being able to manufacture the third element 22 easily. However, the third element 22 does not necessarily have to have the cut portion 49 formed therein. Forming the inclined portions 48 of the third element 22 has effect of reducing the height and size of the antenna device 100.

As illustrated in FIG. 3A, in the third element 22, the engagement holes 25, the engagement hole 26, and the engagement holes 27 are formed. The engagement holes 25 are parts with which the engagement claws 32 of the holder 30 are to engage, the engagement hole 26 is a part with which the engagement claw 33 of the holder 30 is to engage, and the engagement holes 27 are parts with which the engagement claws 34 of the holder 30 are to engage.

The fourth element 23 is an element to which the outer conductor 86 of the second coaxial cable 82 is connected, as illustrated in FIG. 3A. The fourth element 23 has a fourth planar portion. In an embodiment of the present disclosure, the fourth element 23 is arranged extending along a direction substantially parallel to the placement surface 65 of the base portion 2. However, the direction in which the fourth element 23 is arranged does not have to be substantially parallel to the placement surface 65 of the base portion 2. The angle of the fourth element 23 with respect to the placement surface 65 of the base portion 2 may be any angle as long as it is smaller than the angle of the third element 22 with respect to the placement surface 65 of the base portion 2.

As illustrated in FIG. 2, the fourth element 23 also has a second outer conductor connection portion 24. The second outer conductor connection portion 24 is a part where the outer conductor 86 of the second coaxial cable 82 is connected. The second outer conductor connection portion 24 is located on the −Y direction side of the fourth element 23. This allows the second coaxial cable 82 connected at the second outer conductor connection portion 24 to be arranged so as to extend, in the +Y direction, beyond the second outer conductor connection portion 24.

The fourth element 23 includes the protruding portions 28. The protruding portions 28 each have the engagement hole 29 formed therein. The engagement hole 29 is a part with which the engagement claw 35 of the holder 30 engages.

### <<Operating Principle of Antenna Under Both Installation Conditions>>

In the antenna device 100 of an embodiment of the present disclosure, each of the first antenna 10 and the second antenna 20 can meet various installation conditions with the single antenna. Specifically, each of the antennas has good antenna characteristics both when it is arranged apart from the external or internal member having a conductor portion and when it is disposed close to the external or internal member having the conductor portion. Thus, in the following, the operating principle of the antenna under both installation conditions will be described using a model assuming the first antenna 10. The following description of the model of the first antenna 10 can apply to the second antenna 20 as well.

### <Free Space>

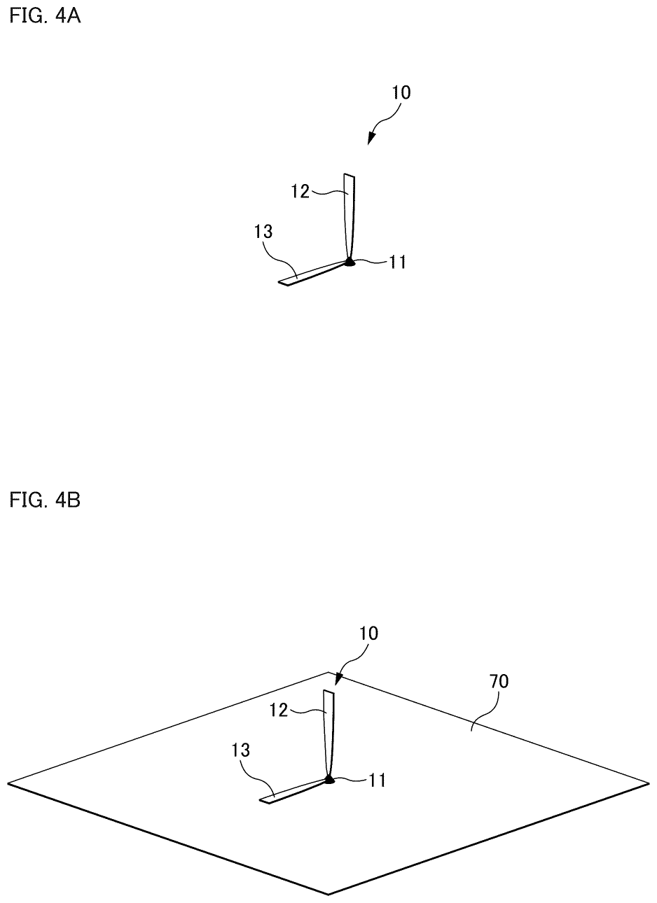

FIG. 4A is an explanatory diagram illustrating a model of the first antenna 10 arranged in free space.

In this model, as illustrated in FIG. 4A, the first antenna 10 has the first feed portion 11, the first element 12 of an elongated plate shape having a planar portion, and the second element 13 of an elongated plate shape having a planar portion (second planar portion). The first element 12 and the second element 13 are fed in the first feed portion 11.

In an embodiment of the present disclosure, the first antenna 10 arranged in free space has an operating principle corresponding to that of a dipole antenna. That is, the second element 13 of the first antenna 10 corresponds to an element on the ground side. Here, in this model, the term “free space” is described as an “imaginary space extending infinitely”. However, in the antenna device 100 of an embodiment of the present disclosure described above, this also includes the case in which the conductor portion that affects the operations of the first antenna 10 and the second antenna 20 is sufficiently apart from the first antenna 10 and the second antenna 20. For example, this also includes the case in which the base portion 2 made of insulating resin is arranged at a part of the housing of the antenna device 100, the housing of the antenna device 100 that serves as a conductor portion being apart from the antenna 10 by a sufficient thickness of the base portion 2 made of insulating resin. When the base portion 2 is a conductor portion such as metal or the like, it is arranged without being spaced apart from the antenna 10.

### <Arrangement Close to Conductor Portion>

FIG. 4B is an explanatory diagram illustrating a model of the first antenna 10 arranged close to an external member (or internal member) 70.

In this model, the external member (or inner member) 70 has a conductor portion. That is, the external member (or internal member) 70 may be a conductor portion in its entirety, or the external member (or internal member) 70 may have a conductor portion in only a part thereof. However, the conductor portion of the external member (or internal member) 70 is formed so as to function as a ground portion, as will be described later. In this model, the external member (or internal member) 70 has a planar portion (first planar portion), and the first antenna 10 is arranged close to the front surface of the external member (or internal member) 70.

The first antenna 10, which is arranged close to the front surface of the external member (or internal member) 70, has an operating principle corresponding to that of a monopole antenna. In this model, the second element 13 of the first antenna 10 is capacitively coupled to the conductor portion of the external member (or internal member) 70, so that the second element 13 functions as a ground portion together with the conductor portion of the external member (or internal member) 70. Here, the second element 13 “functioning as the ground portion together with the conductor portion” refers to that the main part of the second element 13 is capacitively coupled thereto at a desired frequency. Thus, it is not limited to the entire second element 13 being capacitively coupled thereto.

Here, the second element 13 has the planar portion extending along the planar portion of the external member (or internal member) 70. In this model, the planar portion of the second element 13 is parallel to the planar portion of the external member (or internal member) 70. Further, the planar portion of the second element 13 may be in close contact with the planar portion of the external member (or internal member) 70 without being spaced apart therefrom.

The above-described phrase “the first antenna 10 is arranged close to the front surface of the external member (or internal member) 70” refers to, in the antenna device 100 of an embodiment of the present disclosure described above, for example, that the second element 13 and the external member (or internal member) 70 are arranged at a distance at which they are capacitively coupled at the frequency supported by the first antenna 10. In the antenna device 100 of an embodiment of the present disclosure, the thickness of the base portion 2 located on the external member (or internal member) 70 side with respect to the second element 13 is small, and thus the second element 13 and the external member (or internal member) 70 are capacitively coupled.

When the external member (or internal member) 70 has a non-conductive portion in a part thereof and a conductive portion in other part thereof, the first antenna 10 may be arranged in a state of being in contact with the non-conductive portion of the external member (or internal member) 70. Then, with the second element 13 of the first antenna 10 being capacitively coupled to the part corresponding to the conductor portion of the external member (or internal member) 70, the second element 13 may function as the ground portion together with the conductor portion of the external member (or internal member) 70.

### <<Frequency Characteristics of VSWR Under Both Installation Conditions>>

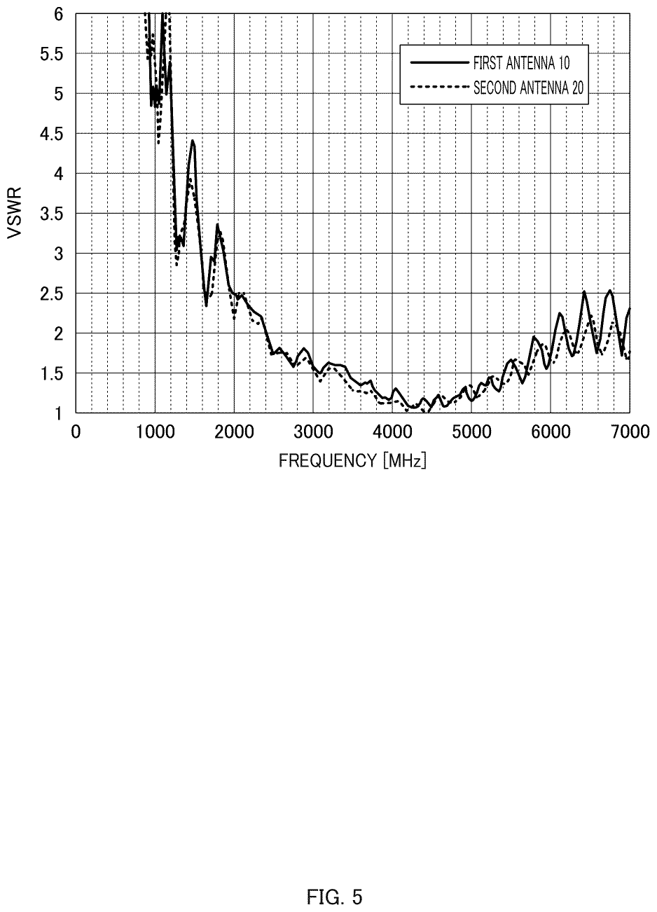

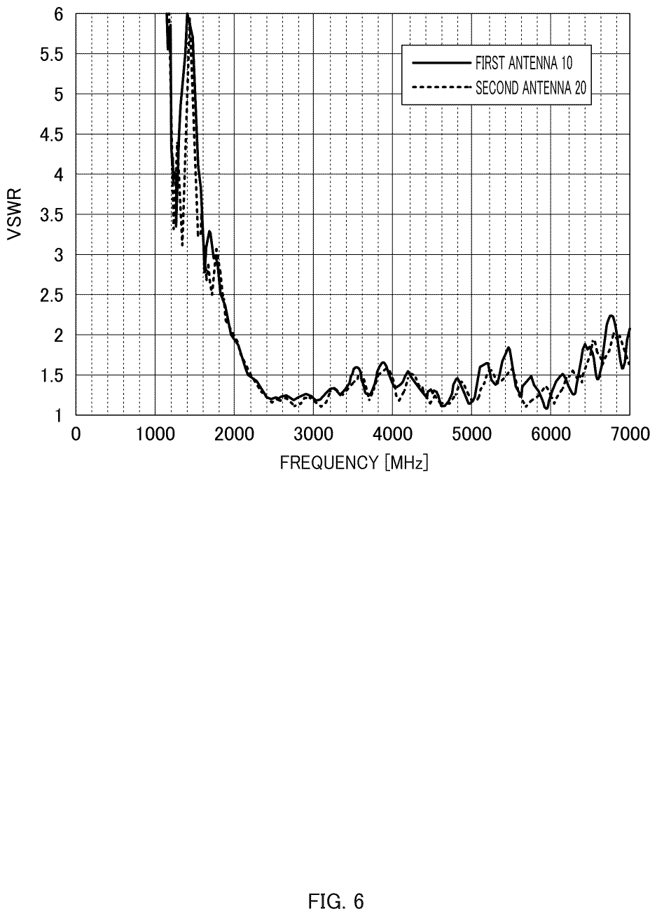

FIG. 5 is a diagram illustrating the frequency characteristics of VSWR of the first antenna 10 and the second antenna 20 arranged in free space. FIG. 6 is a diagram illustrating the frequency characteristics of VSWR of the first antenna 10 and the second antenna 20 arranged close to the external member (or internal member) 70.

In FIGS. 5 and 6, the horizontal axis represents frequency and the vertical axis represents voltage standing wave ratio (VSWR). In FIGS. 5 and 6, the calculation results in the first antenna 10 are given by solid lines, and the calculation results in the second antenna 20 are given by dashed lines.

As illustrated in FIGS. 5 and 6, the first antenna 10 has a VSWR of 3 or less in the range from 2 GHz to 6 GHz and has good VSWR characteristics. Further, as illustrated in FIGS. 5 and 6, the second antenna 20 has a VSWR of 3 or less in the range from 2 GHz to 6 GHz, and has good VSWR characteristics.

Accordingly, in the antenna device 100 of an embodiment of the present disclosure, each of the first antenna 10 and the second antenna 20 has good antenna characteristics under the installation conditions illustrated in FIG. 4A and also under the installation conditions illustrated in FIG. 4B, described above. That is, the antenna device 100 of an embodiment of the present disclosure can meet various installation conditions with the single antenna.

Here, when the various installation conditions are explained with this model, the conditions are the case of free space (see FIG. 4A) and the case of the antenna being close to or in contact with the external member (or internal member) 70 (FIG. 4B), described above. The case of free space includes, for example, the case in which the base portion 2 made of insulating resin may have a sufficient thickness, and the like, and thus includes the case in which the conductor portion is sufficiently spaced apart from the placement surface of the antenna device 100.

### <<Antenna Device of Modification Example>>

<Antenna device 100A of First Modification Example>

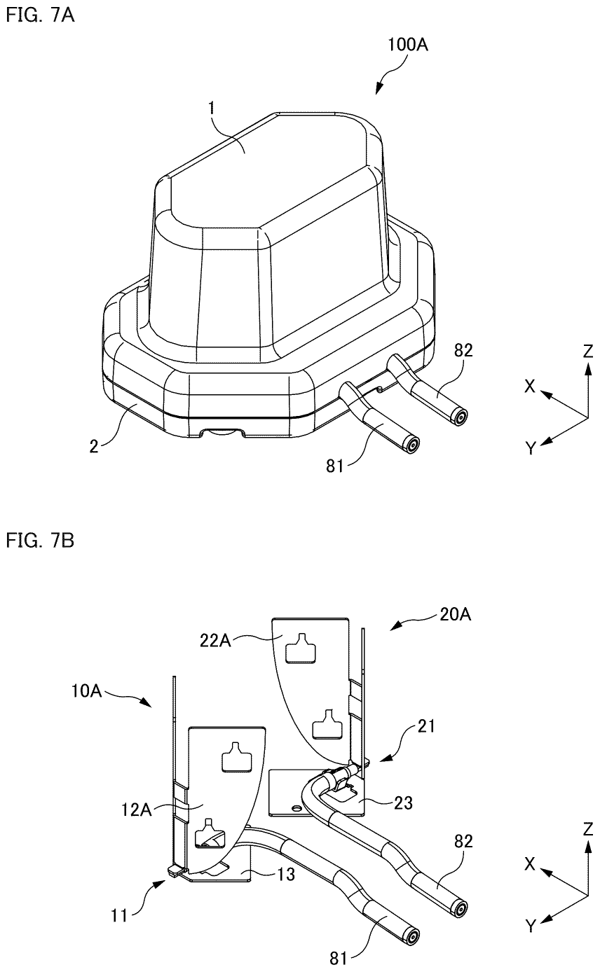

FIG. 7A is a perspective view of an antenna device 100A of a first modification example. FIG. 7B is a perspective view illustrating how coaxial cables are connected to the first antenna 10A and the second antenna 20A, respectively.

The first element 12A of the first antenna 10A is different from the first element 12 of the first antenna 10 of an embodiment of the present disclosure in that it has no inclined portion and is formed only with a rising portion that rises in the +Z direction. Further, the third element 22A of the second antenna 20A is also different from the third element 22 of the second antenna 20 of an embodiment of the present disclosure in that it has no inclined portion and is formed only with a rising portion that rises in the +Z direction.

As compared to the first antenna 10 and the second antenna 20 of an embodiment of the present disclosure, the first antenna 10A and the second antenna 20A of this modification example increase in size in the height direction by an amount corresponding to the size of the upper part of the element not formed into an inclined portion, and thus the entire antenna device 100A increases in size. However, the first antenna 10A and the second antenna 20A of this modification are capable of meeting various installation conditions with a single antenna, as with the first antenna 10 and the second antenna 20 of an embodiment of the present disclosure.

### <<Antenna Device 100B of Second Modification Example>>

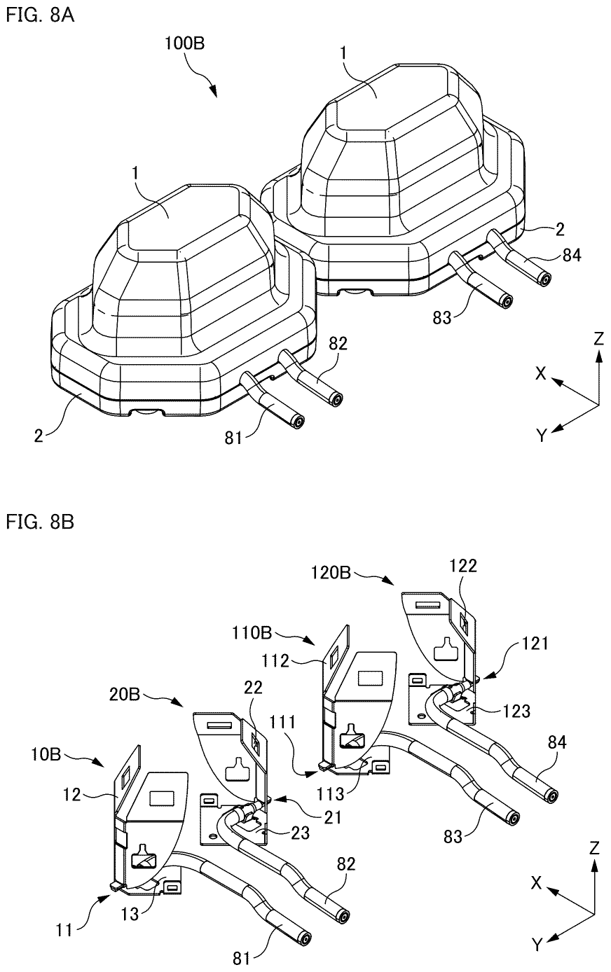

FIG. 8A is a perspective view of an antenna device 100B of a second modification example. FIG. 8B is a perspective view illustrating how coaxial cables are connected to a first antenna 10B, a second antenna 20B, a third antenna 110B, and a fourth antenna 120B, respectively.

In the antenna device 100B, two sets of configurations as in the antenna device 100 of an embodiment of the present disclosure are arranged side by side in the Y direction. Specifically, as illustrated in FIGS. 8A and 8B, on the +Y direction side, the first antenna 10B and the second antenna 20B are housed in a case portion 1 and a base portion 2, and on the −Y direction side, the third antenna 110B and the fourth antenna 120B are housed in another case portion 1 and a base portion 2.

In this modification example, each of the first antenna 10B, second antenna 20B, third antenna 110B and fourth antenna 120B can meet various installation conditions with a single antenna, as with the first antenna 10 and second antenna 20 of the an embodiment of the present disclosure.

### <<Isolation Between/Among Multiple Antennas>>

In an embodiment of the present disclosure, the antenna device has multiple antennas. For example, the antenna device 100 of an embodiment of the present disclosure has two antennas the first antenna 10 and the second antenna 20, as described above. Further, the antenna device 100B of the second modification example has four antennas, the first antenna 10B, the second antenna 20B, the third antenna 110B, and the fourth antenna 120B.

Incidentally, the multiple antennas may be arranged close to one another in some cases. In such cases, good isolation between/among the multiple antennas is desired. Thus, a model of an antenna unit including multiple antennas is used to consider isolation between/among the multiple antennas.

### <First Antenna Unit 91>

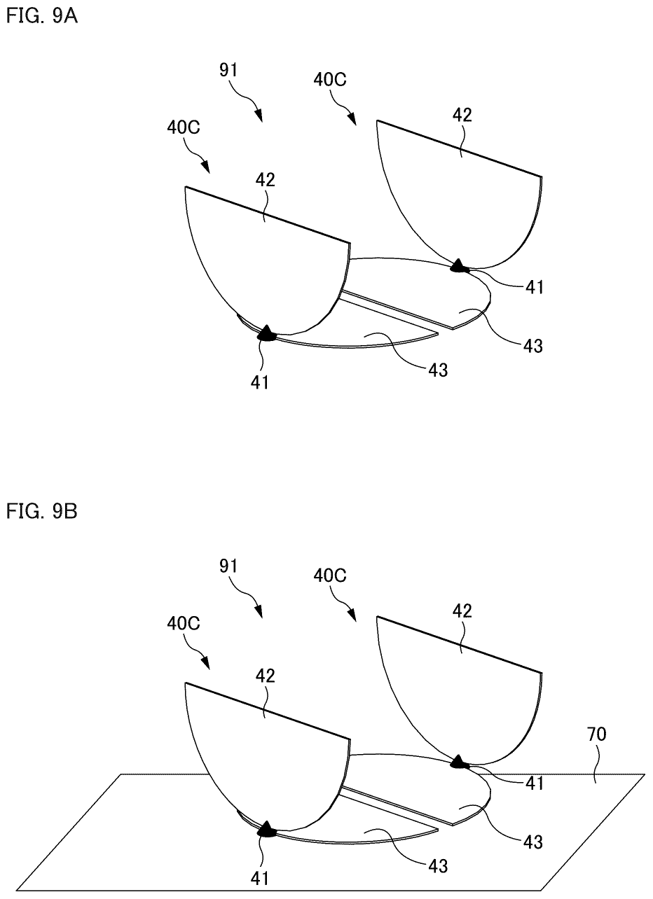

FIG. 9A is an explanatory diagram illustrating a model of the first antenna unit 91 in an embodiment of the present disclosure arranged in free space. FIG. 9B is an explanatory diagram illustrating the model of the first antenna unit 91 of an embodiment of the present disclosure arranged close to the external member (or internal member) 70.

The positional relationship between antennas 40C in the first antenna unit 91 illustrated in FIGS. 9A and 9B corresponds to the positional relationship between the first antenna 10 and the second antenna 20 illustrated in FIGS. 3A and 3B. That is, in the first antenna unit 91, elements 43 corresponding to the second element 13 of the first antenna 10 and the fourth element 23 of the second antenna 20 are close to each other. Further, elements 42 corresponding to the first element 12 of the first antenna 10 and the third element 22 of the second antenna 20 are spaced apart from each other.

### <Second Antenna Unit 92>

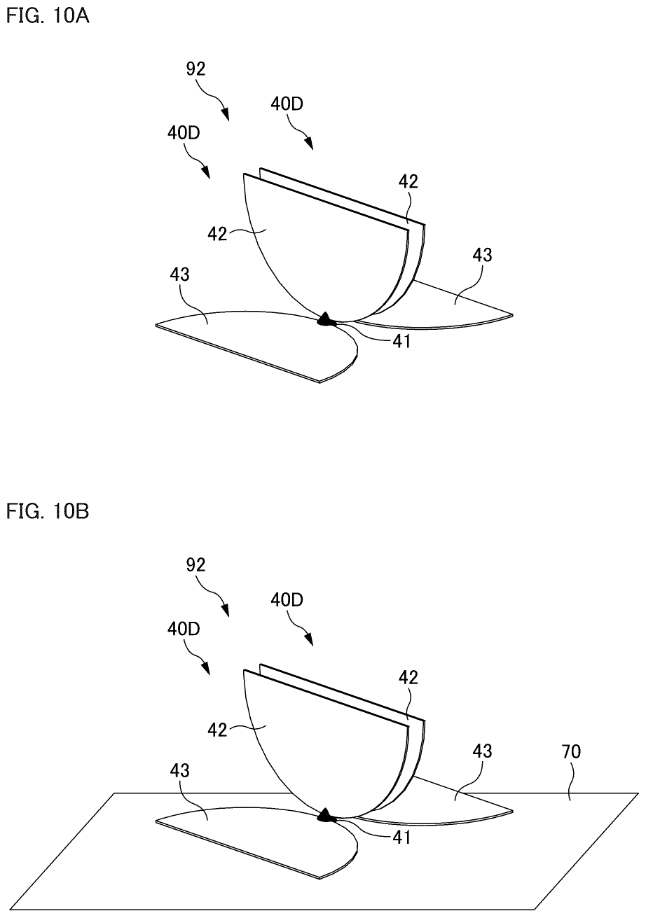

FIG. 10A is an explanatory diagram illustrating a model of a second antenna unit 92 in an embodiment of the present disclosure arranged in free space. FIG. 10B is an explanatory diagram illustrating the model of the second antenna unit 92 in an embodiment of the present disclosure arranged close to the external member (or internal member) 70.

The positional relationship between antennas 40D in the second antenna unit 92 illustrated in FIGS. 10A and 10B corresponds to the positional relationship between the second antenna 20B and the third antenna 110B illustrated in FIG. 8B. That is, in the second antenna unit 92, the elements 42, which correspond to the third element 22 of the second antenna 20B and the fifth element 112 of the third element 110B, are close to each other. Furthermore, the elements 43, which correspond to the fourth element 23 of the second antenna 20B and the sixth element 113 of the third element 110B, are spaced apart from each other.

### <Antenna Unit 90>

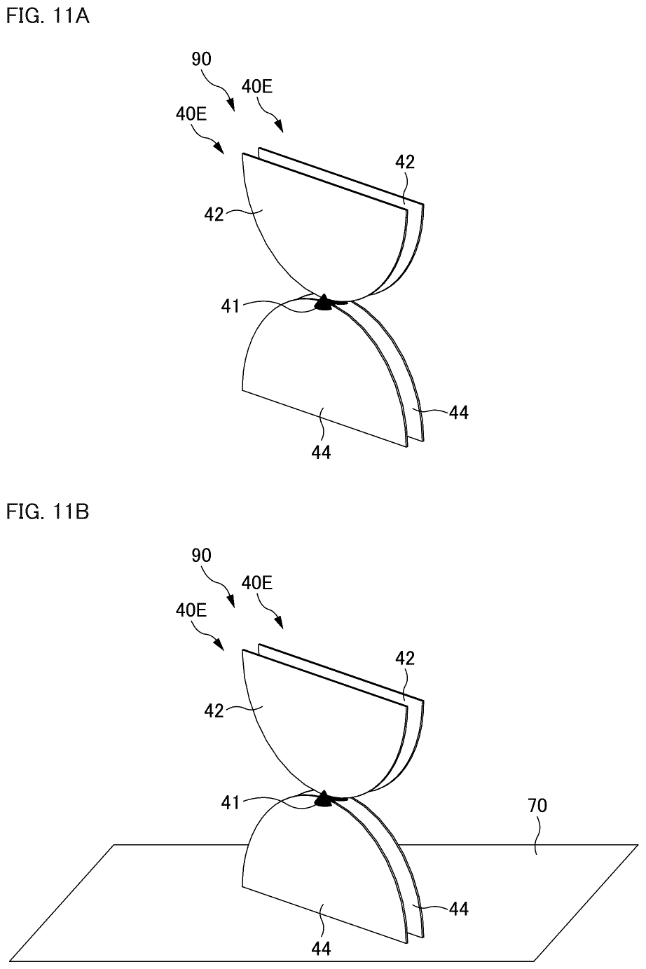

FIG. 11A is an explanatory diagram illustrating a model of an antenna unit 90 of a comparative example arranged in free space. FIG. 11B is an explanatory diagram illustrating the model 44 the antenna unit 90 of the comparative example arranged close to the external member (or internal member) 70.

In the antenna unit 90 of the comparative example illustrated in FIGS. 11A and 11B, the elements 42 are close to each other and the elements 44 are close to each other.

### <Frequency Characteristics of Isolation Between/Among Multiple Antennas Under Both Installation Conditions>

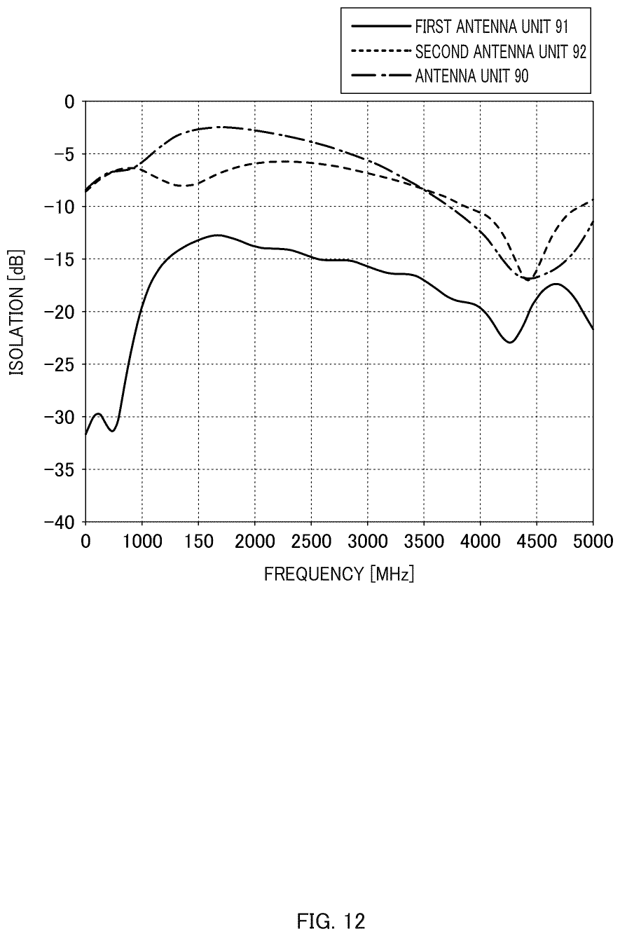

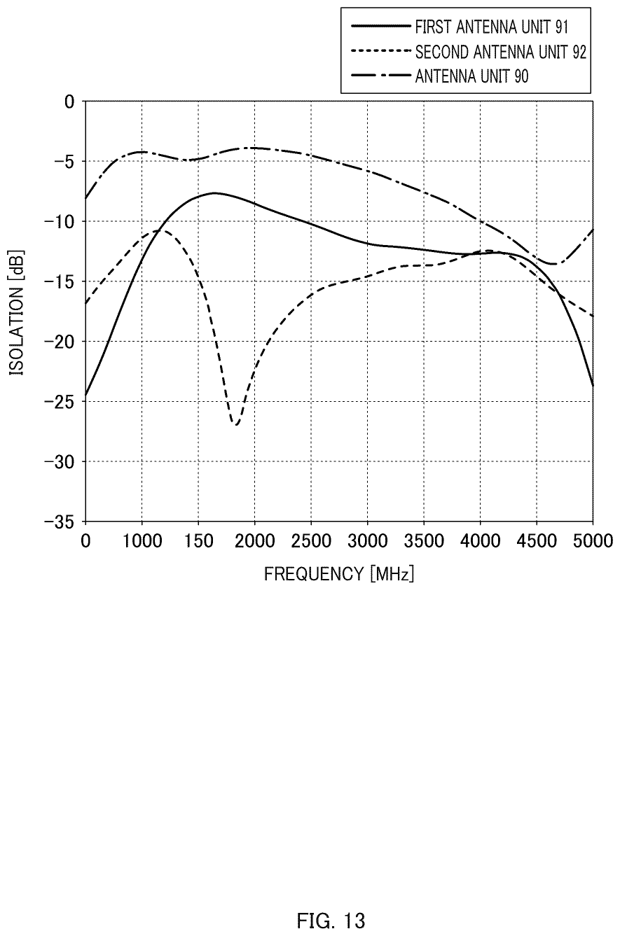

FIG. 12 is a diagram illustrating frequency characteristics of isolation among the first antenna unit 91, the second antenna unit 92, and the antenna unit 90 arranged in free space. FIG. 13 is a diagram illustrating frequency characteristics of isolation among the first antenna unit 91, the second antenna unit 92, and the antenna unit 90, which are arranged close to the external member (or internal member) 70.

In FIGS. 12 and 13, the horizontal axis represents frequency, and the vertical axis represents isolation. In FIGS. 12 and 13, the calculation results between the antennas 40C of the first antenna unit 91 are given by solid lines, the calculation results of the antennas 40D of the second antenna unit 92 are given by dashed lines, and the calculation results of the antennas 40E of the antenna unit 90 are given by dotted-dashed lines.

As illustrated in FIGS. 12 and 13, the first antenna unit 91 and the second antenna unit 92 of an embodiment of the present disclosure have substantially an isolation of −5 dB or less, and have good isolation characteristics. Meanwhile, in the antenna unit 90 of the comparative example, it can be seen, as illustrated in FIGS. 12 and 13, that there are frequency bands in which isolation exceeds −5 dB, and isolation is deteriorated.

Accordingly, even if the multiple antennas are arranged close to each other, it can be seen that they have good isolation characteristics, as long as the positional relationship of the elements of the antennas is as in the first antenna unit 91 and the second antenna unit 92.

### <<Assembly Procedure of Antenna Device 100>>

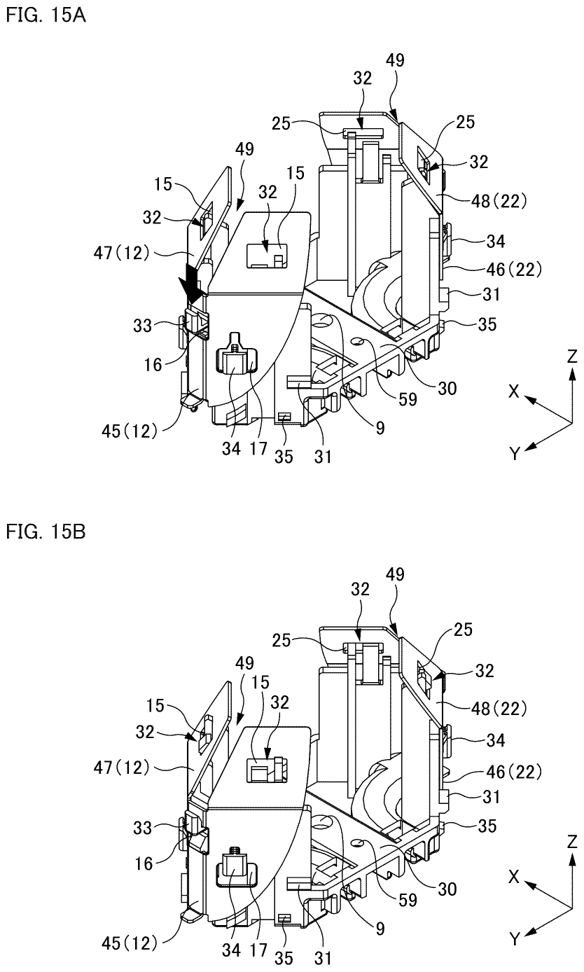

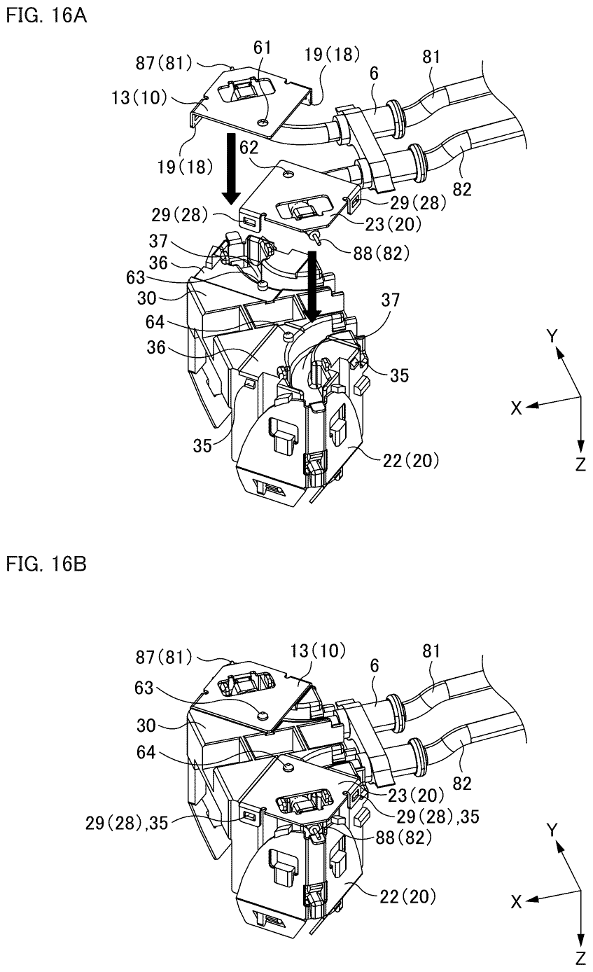

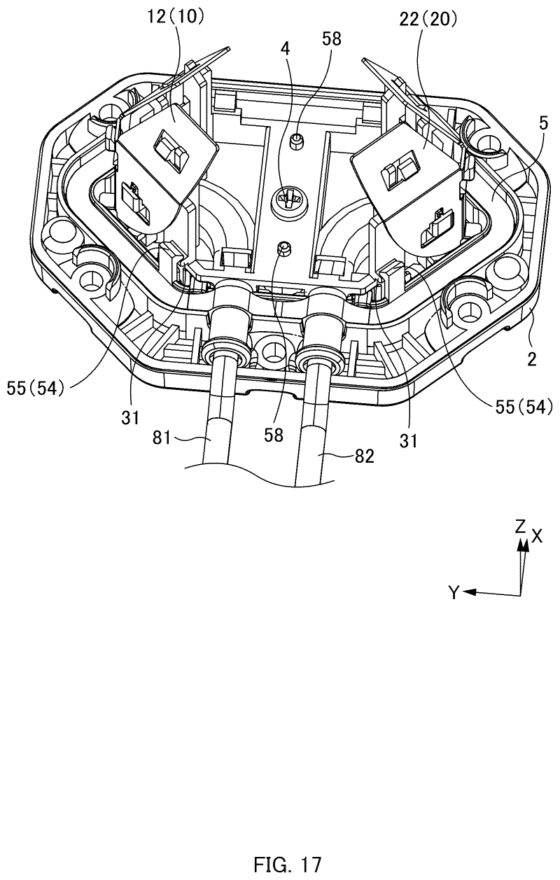

The assembly procedure of the antenna device 100 will be described below with reference to FIGS. 14, 15A, 15B, 16A, 16B, and 17. The antenna device 100 according to an embodiment of the present disclosure is manufactured through the following five steps.
(1) Connecting coaxial cables to the second element 13 and the fourth element 23 (see FIG. 14)
(2) Assembling the holder 30, and the first element 12 and the third element 22 (see FIGS. 15A and 15B)
(3) Assembling the holder 30, and the second element 13 and the fourth element 23 (see FIGS. 16A and 16B)
(4) Assembling the base portion 2 and the holder 30 (see FIG. 17)
(5) Assembling the case portion 1 and the base portion 2 (not illustrated)

For convenience of explanation, these five steps are arranged in the above-described order, but the order of (1) to (5) may be changed as appropriate.

### (1) Connecting the Coaxial Cables to the Second Element 13 and the Fourth Element 23

FIG. 14 is a perspective view illustrating how the first coaxial cable 81 is connected to the second element 13 and how the second coaxial cable 82 is connected to the fourth element 23.

First, as illustrated in FIG. 14, the outer conductor 85 of the first coaxial cable 81 is connected at the first outer conductor connection portion 14 of the second element 13 by soldering and/or the like. Similarly, the outer conductor 86 of the second coaxial cable 82 is connected at the second outer conductor connection portion 24 of the fourth element 23 by soldering and/or the like.

Further, the first coaxial cable 81 is arranged so as to extend, in the −Y direction, beyond the first outer conductor connection portion 14, and the second coaxial cable 82 is arranged so as to extend, in the +Y direction, beyond the second outer conductor connection portion 24. This can make the antenna device 100 more compact.

### (2) Assembling the Holder 30, and the First Element 12 and the Third Element 22

FIG. 15A is a perspective view illustrating a state in the middle of assembling the holder 30, and the first element 12 and third element 22. FIG. 15B is a perspective view illustrating a state in which the assembly of the holder 30, and the first element 12 and third element 22 is completed.

The first element 12 is mounted to the holder 30 in the direction given by the arrow in FIG. 15A, thereby being able to assemble the holder 30 and the first element 12. In this event, the engagement claws 32 on the +Y direction side of the holder 30 and the edges of the engagement holes 15 of the first element 12 engage with each other. Further, the engagement claw 33 on the +Y direction side of the holder 30 and the edge of the engagement hole 16 of the first element 12 engage with each other. Further, the engagement claws 34 on the +Y direction side of the holder 30 and the edges of the engagement holes 17 of the first element 12 engage with each other.

The third element 22 is mounted to the holder 30 in the same manner as in the first element 12, thereby being able to assemble the holder 30 and the third element 22. In this event, the engagement claws 32 on the −Y direction side of the holder 30 and the edges of the engaging holes 25 of the third element 22 engage with each other. Further, the engagement claw 33 on the −Y direction side of the holder 30 and the edge of the engaging hole 26 of the third element 22 engage with each other. Further, the engagement claws 34 on the −Y direction side of the holder 30 and the edges of the engaging holes 27 of the third element 22 engage with each other.

### (3) Assembling the Holder 30, and the Second Element 13 and Fourth Element 23

FIG. 16A is a perspective view illustrating a state in the middle of assembling the holder 30, and the second element 13 and fourth element 23. FIG. 16B is a perspective view illustrating a state in which the assembly of the holder 30, and the second element 13 and fourth element 23 is completed.

The second element 13 is mounted to the holder 30 in the direction given by the arrow in FIG. 16A, thereby being able to assemble the holder 30 and the second element 13. In this event, the positioning protrusion 63 of the holder 30 is fitted into the positioning hole 61 formed in the second element 13, thereby positioning the second element 13 with respect to the holder 30. The engagement claws 35 on the +Y direction side of the holder 30 and the edges of the engagement holes 19 formed in the protruding portions 18 of the second element 13 engage with each other.

The fourth element 23 is mounted to the holder 30 in the direction given by the arrow in FIG. 16A, thereby being able to assemble the holder 30 and the fourth element 23. In this event, the positioning protrusion 64 of the holder 30 is fitted into the positioning hole 62 formed in the fourth element 23, thereby positioning the fourth element 23 with respect to the holder 30. The engagement claws 35 on the −Y direction side of the holder 30 and the edges of the engaging holes 29 formed in the protruding portions 28 of the fourth element 23 engage with each other.

### (4) Assembling the Base Portion 2 and the Holder 30

FIG. 17 is a perspective view illustrating a state in which the assembly of the base portion 2 and the holder 30 is completed.

As illustrated in FIG. 17, the holder 30 is attached to the base portion 2. In this event, the positioning protrusions 58 of the base portion 2 are fitted into the positioning holes 59 of the holder 30, thereby positioning the holder 30 with respect to the base portion 2. Further, the engagement claws 31 of the holder 30 and the engagement claws 55 of the base portion 2 engage with each other. Furthermore, by tightening the screws 4, the holder 30 and the base portion 2 can be fixed together.

### (5) Assembling the Case Portion 1 and the Base Portion 2

Finally, the case portion 1 and the base portion 2 are assembled. The screws 3 illustrated in FIG. 2 described above are fastened, thereby being able to fix the case portion 1 and the base portion 2 together.

### Summary

According to the present Description, an antenna device of aspects described below is provided.

### (Aspect 1)

An aspect 1 is the first antenna 10 including the first feed portion 11, the first element 12 connected to the first feed portion 11, the first element 12 rising with respect to the surface of the external member (or internal member) 70, and the second element 13 connected to the first feed portion 11, the second element 13 extending along the direction in which the angle formed by the second element 13 with the surface is smaller than the angle formed by the first element 12 with the surface.

A “predetermined member” corresponds to the “external member (or internal member) 70” in an aspect described above.

According to an aspect described above, various installation conditions can be met with the single antenna.

### (Aspect 2)

In an aspect 2, the external member (or internal member) 70 includes the conductor portion, and the second element 13 and the conductor portion are capacitively coupled.

According to an aspect described above, various installation conditions can be met with the single antenna.

### (Aspect 3)

In an aspect 3, the second element 13 extends along a direction substantially parallel to the surface.

According to an aspect described above, various installation conditions can be met with the single antenna.

### (Aspect 4)

In an aspect 4, the external member (or internal member) 70 includes the first planar portion, the second element 13 has the second planar portion, and the first planar portion and the second planar portion are close to or in contact with each other.

According to an aspect described above, various installation conditions can be met with the single antenna.

According to the present Description, an antenna device of aspects described below is provided.

### (Aspect 5)

An aspect 5 is an antenna device 100 including the first antenna 10 and the first coaxial cable 81 connected to the first antenna 10, the first antenna 10 including the first feed portion 11, the first element 12 connected to the first feed portion 11, the first element 12 rising with respect to the surface of the external member (or internal member) 70, and the second element 13 connected to the first feed portion 11, the second element 13 extending along a direction in which the angle formed by the second element 13 with the surface is smaller than the angle formed by the first element 12 with the surface.

According to an aspect described above, various installation conditions can be met with the single antenna.

### (Aspect 6)

In an aspect 6, the external member (or internal member) 70 includes the conductor portion, and the second element 13 and the conductor portion are capacitively coupled.

According to an aspect described above, various installation conditions can be met with the single antenna.

### (Aspect 7)

An aspect 7 further includes the second antenna 20 and the second coaxial cable 82 connected to the second antenna 20, the second antenna 20 including the second feed portion 21, the third element 22 connected to the second feed portion 21, the third element 22 rising with respect to the surface, and the fourth element 23 connected to the second feed portion 21, the fourth element 23 extending in a direction in which the angle of the fourth element 23 with respect to the surface is smaller than the angle of the third element 22 with respect to the surface.

According to an aspect described above, various installation conditions can be met with the single antenna.

### (Aspect 8)

In an aspect 8, the external member (or internal member) 70 includes the conductor portion, and the fourth element 23 and the conductor portion are capacitively coupled.

According to an aspect described above, various installation conditions can be met with the single antenna.

### (Aspect 9)

An aspect 9 further includes the holder 30 configured to support the first antenna 10 and the second antenna 20 such that the first antenna 10 and the second antenna 20 face each other.

According to an aspect described above, it is possible to improve isolation between the first antenna 10 and the second antenna 20.

### (Aspect 10)

In an aspect 7, at least one of the second element 13 and the fourth element 23 extends along a direction substantially parallel to the surface.

According to an aspect described above, various installation conditions can be met with the single antenna.

### (Aspect 11)

In an aspect 8, the outer member (or inner member) 70 includes the first planar portion, the second element 13 includes the second planar portion, and the fourth element 23 includes the fourth planar portion. Further, the first planar portion and the second planar portion are close to or in contact with each other, and the first planar portion and fourth planar portion are close to or in contact with each other.

According to an aspect described above, various installation conditions can be met with the single antenna.

### (Aspect 12)

In an aspect 12, the second element 13 extends, in the −Y direction, from the first feed portion 11, and the fourth element 23 extends, in the +Y direction opposite to the −Y direction, from the second feed portion 21.

A “first direction” corresponds to the “−Y direction” in an aspect described above. A “second direction” corresponds to the “+Y direction” in an aspect described above.

According to an aspect described above, various installation conditions can be met with the single antenna, and isolation between the first antenna 10 and the second antenna 20 can be improved.

### (Aspect 13)

In an aspect 13, the second element 13 includes the first outer conductor connection portion 14 where the first coaxial cable 81 is connected, and the first coaxial cable 81 extends, in the −Y direction, beyond the first outer conductor connection portion 14. The fourth element 23 includes the second outer conductor connection portion 24 where the second coaxial cable 82 is connected, and the second coaxial cable 82 extends, in the +Y direction, beyond the second outer conductor connection portion 24.

According to an aspect described above, the antenna device 100 can be made more compact.

According to the present Description, an antenna unit of an aspect described below is provided.

### (Aspect 14)

Aspect 14 is the first antenna unit 91 (or the second antenna unit 92) including a plurality of antennas 40C (or antennas 40D). Each of the plurality of antennas 40C (or antennas 40D) includes the feed portion 41, and the element 42 and the element 43, the element 42 and the element 43 being configured to be fed at the feed portion 41, the element 42 rising with respect to the surface of the external member (or internal member) 70, the element 43 extending in a direction in which the angle of the element 43 with respect to the surface is smaller than the angle of the element 42 with respect to the surface, and each of the plurality of antennas 40C (or antennas 40D) is close to or in contact with each other.

A “first element” corresponds to the “element 42” in an aspect described above. A “second element” corresponds to the “element 43” in an aspect described above.

According to an aspect described above, various installation conditions can be met with a single antenna, and isolation between/among a plurality of antennas can be improved.

Embodiments of the present disclosure described above are simply to facilitate understanding of the present disclosure and are not in any way to be construed as limiting the present disclosure. The present disclosure may variously be changed or altered without departing from its essential features and encompass equivalents thereof.

### REFERENCE SIGNS LIST

10, 10A, 10B first antenna
11 first feed portion
12, 12A first element;
13 second element
14 first outer conductor connection portion
20, 20A, 20B second antenna
21 second feed portion
22, 22A third element
23 fourth element
24 second outer conductor connection portion
40 holder
40C, 40D, 40E antenna
42 feed portion
42, 43, 44 element
70 external member
81 first coaxial cable
82 second coaxial cable
90 antenna unit
91 first antenna unit
92 second antenna unit
100, 100A, 100B antenna device

1. An antenna comprising:
a feed portion;
a first element connected to the feed portion, the first element rising from a surface of a predetermined member; and
a second element connected to the feed portion, the second element extending along a direction in which an angle formed by the second element with the surface is smaller than an angle formed by the first element with the surface.

2. The antenna according to claim 1, wherein
the predetermined member includes a conductor portion, and
the second element and the conductor portion are capacitively coupled.

3. The antenna according to claim 1, wherein
the second element extends along a direction substantially parallel to the surface.

4. The antenna according to claim 1, wherein
the predetermined member includes a first planar portion,
the second element includes a second planar portion, and
the first planar portion and the second planar portion are close to or in contact with each other.

5. An antenna device comprising:
a first antenna; and
a first coaxial cable connected to the first antenna,
the first antenna including
a first feed portion,
a first element connected to the first feed portion, the first element rising with respect to a surface of a predetermined member, and
a second element connected to the first feed portion, the second element extending along a direction in which an angle formed by the second element with the surface is smaller than an angle formed by the first element with the surface.

6. The antenna device according to claim 5, wherein
the predetermined member includes a conductor portion, and
the second element and the conductor portion are capacitively coupled.

7. The antenna device according to claim 5, further comprising:
a second antenna; and
a second coaxial cable connected to the second antenna,
the second antenna including
a second feed portion,
a third element connected to the second feed portion, the third element rising with respect to the surface, and
a fourth element connected to the second feed portion, the fourth element extending along a direction in which an angle formed by the fourth element with the surface is smaller than an angle formed by the third element with the surface.

8. The antenna device according to claim 7, wherein
the predetermined member includes the conductor portion, and
the fourth element and the conductor portion are capacitively coupled.

9. The antenna device according to claim 7, further comprising:
a holder configured to support the first antenna and the second antenna such that the first antenna and the second antenna face each other.

10. The antenna device according to claim 7, wherein
at least one of the second element or the fourth element extends along a direction substantially parallel to the surface.

11. The antenna device according to claim 7, wherein
the predetermined member includes a first planar portion,
the second element includes a second planar portion,
the fourth element includes a fourth planar portion,
the first planar portion of the predetermined member and the second planar portion of the second element are close to or in contact with each other, and
the first planar portion of the predetermined member and the fourth planar portion of the fourth element are close to or in contact with each other.

12. The antenna device according to claim 7, wherein
the second element extends, in a first direction, from the first feed portion, and
the fourth element extends, in a second direction opposite to the first direction, from the second feed portion.

13. The antenna device according to claim 12, wherein
the second element includes a first outer conductor connection portion where the first coaxial cable is connected,
the first coaxial cable extends, in the first direction, beyond the first outer conductor connection portion,
the fourth element includes a second outer conductor connection portion where the second coaxial cable is connected, and
the second coaxial cable extends, in the second direction, beyond the second outer conductor connection portion.

14. An antenna unit comprising a plurality of antennas, wherein
each of the plurality of antennas includes a feed portion, and a first element and a second element, the first element and the second element being configured to be fed at the feed portion,
the first element rises with respect to a surface of a predetermined member,
the second element extends along a direction in which an angle formed by the second element with the surface is smaller than an angle formed by the first element with the surface, and
the plurality of antennas are close to or in contact with each other.
